(19) United States
(12) Patent Application Publication
(10) Pub. No.: US 2024/0278292 A1
(43) Pub. Date: Aug. 22, 2024

(54) ULTRASONIC SHOWER CLEANING DEVICE

(71) Applicant: KAIJO CORPORATION, Tokyo (JP)

(72) Inventors: Kosuke HIRANO, Tokyo (JP); Yasuhiro IMAZEKI, Tokyo (JP)

(21) Appl. No.: 18/024,636

(22) PCT Filed: Sep. 28, 2020
(86) PCT No.: PCT/JP2020/036575

§ 371 Date: Mar. 3, 2023

(51) Int. Cl. B08B 3/12

(52) U.S. Cl. CPC B08B 3/12

(57) ABSTRACT

Provided is an ultrasonic shower cleaning device configured to apply an ultrasonic vibration to a cleaning liquid to perform cleaning. The ultrasonic shower cleaning device efficiently applies the ultrasonic vibration to the cleaning liquid flowing through a flow passage so as to allow the cleaning liquid to be ejected in a spot-like or linear fashion to an object to be cleaned without scattering the cleaning liquid. An ultrasonic shower cleaning device (1) includes: a vibrating body (20), which defines a part of the flow passage (48), and is configured to apply an ultrasonic vibration to the cleaning liquid; and a discharge port (47) configured to allow discharge of the cleaning liquid flowing from the flow passage. The vibrating body is provided so as to be continuous from an inside of the flow passage and project to an outside of the discharge port.

### TECHNICAL FIELD

The present invention relates to an ultrasonic shower cleaning device e configured to apply an ultrasonic vibration to a cleaning liquid to perform cleaning, in particular, an ultrasonic shower cleaning device configured to efficiently apply an ultrasonic vibration to a cleaning liquid flowing through a flow passage and allow the cleaning liquid to be ejected in a spot-like or linear fashion to an object to be cleaned without scattering the cleaning liquid.

### BACKGROUND ART

Hitherto, an ultrasonic cleaning device generally includes an ultrasonic transducer mounted on a lower surface of a cleaning bath and performs cleaning in the following manner. After a cleaning liquid is supplied to the cleaning bath, an object to be cleaned is immersed into the cleaning bath and ultrasonic vibrations are applied to the lower surface of the cleaning bath so as to perform the cleaning.

Further, as a device that cleans, for example, a liquid crystal panel and a semiconductor wafer, there is known a shower type ultrasonic cleaning device that applies ultrasonic vibrations to a cleaning liquid and jets the cleaning liquid, to which the ultrasonic vibrations are applied, in a shower-like manner so as to ultrasonically clean the above-mentioned objects to be cleaned.

For example, in Patent Literature 1, there is disclosed a spot shower type ultrasonic cleaning device, for which an installation adjustment is easy without the need of a strict distance adjustment between a leading end of a nozzle and an object to be cleaned. The spot shower type ultrasonic cleaning device jets a cleaning liquid, to which an ultrasonic wave is applied, from the nozzle toward the object to be cleaned so as to remove contamination such as particles.

Based on the disclosure of Patent Literature 1, the spot shower type ultrasonic cleaning device includes a nozzle, an ultrasonic transducer having a circular plate-like shape, and a liquid supply port for a cleaning liquid. The nozzle is mounted to a leading end of a casing. The ultrasonic transducer is arranged so as to be opposed to a rear end of the nozzle. The liquid supply port is formed in a side surface of the casing. A discharge hole of the nozzle is formed as a linear round hole having a constant diameter.

The ultrasonic wave emitted from the ultrasonic transducer is applied to the cleaning liquid supplied through the liquid supply port, and the cleaning liquid is jetted from the leading end of the nozzle so as to clean the object to be cleaned, which is arranged in front of the nozzle. With the arrangement described above, the ultrasonic wave emitted from the nozzle does not form a focal point, and hence there is no need of strict adjustment of the distance between the object to be cleaned and the leading end of the nozzle.

Further, in Patent Literature 2, there is disclosed a nozzle shower type ultrasonic cleaning device that defines an ultrasonic wave propagation passage by causing a liquid to flow out from a discharge port of a reservoir and bringing the liquid into contact with an area to be cleaned so as to clean the area to be cleaned of, for example, a biological body with ultrasonic vibrations.

According to Patent Literature 2, the nozzle shower type ultrasonic cleaning device includes an ultrasonic-wave transmitting body. An ultrasonic transducer is mounted to one end portion of the ultrasonic-wave transmitting body. An end surface of another end portion of the ultrasonic-wave transmitting body functions as an ultrasonic-wave emitting surface. The ultrasonic-wave transmitting body is retained and fixed in an airtight manner onto an inner peripheral surface of a housing in the vicinity of the ultrasonic-wave emitting surface with use of a retaining member such as an O-ring formed of an elastic body. Thus, the ultrasonic-wave transmitting body can be retained while ultrasonic vibrations on a side surface of the ultrasonic-wave emitting surface is prevented from being suppressed by the retaining member. Further, the side surface of the ultrasonic-wave transmitting body and a part of the ultrasonic transducer can be prevented from being brought into contact with the liquid to thereby improve efficiency.

Further, in FIG. 12 of Patent Literature 2, there is disclosed an ultrasonic cleaning device including a vibration transmitting body that is exposed to an outside of a casing as related art. In this related art, as described in the paragraph

of Patent Literature 2, a vibration surface of the ultrasonic cleaning device is brought into direct contact with an area to be cleaned of an object to be cleaned that is immersed into water in a reservoir so that contamination is removed by vibration energy of ultrasonic waves at about several tens of kHz. Specifically, in this related art, unlike the spot shower type ultrasonic cleaning device, the vibration surface that ultrasonically vibrates is brought into direct contact with the area to be cleaned so as to perform cleaning.

Further, in Patent Literature 3, there is disclosed a stream ultrasonic cleaner nozzle. The stream ultrasonic cleaner nozzle includes a nozzle main body and a vibrating body. The nozzle main body includes a cavity portion having a tapered shape. The cavity portion defines a part of a flow passage which allows flow of a cleaning liquid. The nozzle main body has a discharge port for discharging a cleaning liquid in the cavity portion, and the discharge port is formed at a distal end of the cavity portion. The vibrating body is fixed onto a front end surface of an ultrasonic transducer so as to be in close contact therewith, is made of a chemical-resistant nonmetallic inorganic material, and occupies a volume of a half or more of an internal space of the cavity portion. The cleaning liquid is caused to flow through a gap defined by an outer surface of the vibrating body and an inner wall surface of the cavity portion.

According to Patent Literature 3, a stream ultrasonic cleaner discharges the cleaning liquid flowing through the gap defined by the outer surface of the vibrating body and the inner wall surface of the cavity portion from the discharge port as a stream. At the time of discharge, ultrasonic waves are superimposed on the cleaning liquid by the ultrasonic transducer and the vibrating body. In this case, most of the internal space of the cavity portion is occupied in advance by the vibrating body. Further, the vibrating body, which is fixed to the ultrasonic transducer so as to be in close contact therewith, becomes a load during vibration. Thus, even when the cavity portion is not filled with the cleaning liquid, boil dry is permitted for a short period of time.

Further, there is known another related-art stream ultrasonic cleaning device including a vibrating body that is built therein. FIG. 7 is a sectional view for illustrating a configuration of a related-art stream ultrasonic cleaning device including a vibrating body that is built therein.

As illustrated in FIG. 7, a stream ultrasonic cleaning device 80 includes a casing 81, a vibrating body 84, an ultrasonic transducer 88, a liquid supply port 82, and a nozzle portion 90. The vibrating body 84 is accommodated in the casing 81. The ultrasonic transducer 88 is provided on one surface of the vibrating body 84. The liquid supply port 82 allows supply of a cleaning liquid 75. The nozzle portion 90 defines a part of a flow passage 94. The nozzle portion 90 defines the flow passage 94 in cooperation with the vibrating body 84. Specifically, the nozzle portion 90 has a nozzle inner wall 91 on an inner side. The vibrating body 84 has an outer peripheral surface 87 that is a contact surface with the cleaning liquid 75. The flow passage is defined by the nozzle inner wall 91 and the outer peripheral surface 87. The cleaning liquid 75 supplied from the liquid supply port 82 is discharged from a discharge port 92 at a distal end of the nozzle inner wall 91 via the flow passage 94.

The stream ultrasonic cleaning device 80 of FIG. 7 is illustrated in cross section. In this case, the stream ultrasonic cleaning device 80 may be configured not only as a spot shower type stream ultrasonic cleaning device that discharges a cleaning liquid in a spot-like fashion but also as a line shower type stream ultrasonic cleaning device that discharges a cleaning liquid in a linear fashion.

As illustrated in FIG. 7, a vibration surface 86 is located at a distal end portion 85 of the vibrating body 84, and applies ultrasonic vibrations to the cleaning liquid. The vibration surface 86 is formed so as to be located deeper inside the casing 81 than the nozzle inner wall 91 that defines the discharge port 92. Further, the stream ultrasonic cleaner disclosed in Patent Literature 3 superimposes an ultrasonic wave onto a cleaning liquid flowing through the gap defined by the outer surface of the vibrating body and the inner wall surface of the cavity portion so as to discharge the cleaning liquid from the discharge port as a stream. The discharge port from which the cleaning liquid is discharged is formed at a distal end of the nozzle main body.

As described above, as illustrated in FIG. 7 and described in Patent Literature 3, the related-art stream ultrasonic cleaning device has the flow passage defined by the vibrating body and the cavity portion of the nozzle main body or the flow passage defined by the nozzle inner wall 91 of the nozzle portion 90 and the outer peripheral surface 87 of the vibrating body 84. The cleaning liquid flowing through the flow passage flows to the distal end portion of the vibrating body and then flows from the vibration surface of the distal end portion of the vibrating body to be discharged from the discharge port.

### CITATION LIST

### Patent Literature

[PTL 1] JP 3256198 B
[PTL 2] JP 3938129 B
[PTL 3] JP 6507358 B

### SUMMARY OF INVENTION

### Technical Problem

In the related-art stream ultrasonic cleaning device 80 illustrated in FIG. 7, the gap between the nozzle inner wall 91 of the nozzle portion 90 and the outer peripheral surface 87 of the vibrating body 84 defines the flow passage 94. Thus, the ultrasonic vibrations applied by the vibrating body 84 to the cleaning liquid 75 undesirably propagate to the nozzle inner wall 91 through the cleaning liquid 75.

As a result, the ultrasonic vibrations applied by the vibration surface 86 of the vibrating body 84 to the cleaning liquid 75 disadvantageously propagate to the nozzle inner wall 91 and are damped. Thus, the cleaning liquid 75 is released from the discharge port 92 to an object to be cleaned 77 under a state in which the ultrasonic vibrations are damped. Accordingly, a sound pressure of the cleaning liquid on which the ultrasonic vibrations are superimposed is reduced, thereby weakening a cleaning action on the object to be cleaned.

Further, when the cleaning liquid 75 flows along the nozzle inner wall 91, air bubbles are sometimes accumulated on a surface or in the vicinity of the distal end portion 85 of the vibrating body 84. The accumulation of air bubbles on the surface of the vibrating body 84 may bring the vibrating body 84 into a boil-dry state, which leads to a risk of a failure of the ultrasonic transducer 88.

Further, the following problems have occurred depending on a width of the discharge port 92 at the distal end portion of the nozzle portion 90. For example, when the discharge port 92 has a large width, the cleaning liquid 75 discharged therefrom has larger diameter and width. As a result, the ultrasonic vibrations that have propagated from the vibrating body 84 to the cleaning liquid 75 are scattered to thereby damp the sound pressure of the ultrasonic vibrations.

Further, a large width of the discharge port 92 may result in, for example, scattering or nonuniformity of the cleaning liquid discharged therefrom. In order to rectify those disturbances, it is required that a larger amount of cleaning liquid be supplied. As a result, the amount of supply of cleaning liquid is increased. Accordingly, a larger amount of cleaning liquid is consumed.

Meanwhile, when the discharge port 92 has a small width, it becomes difficult for the cleaning liquid to which the ultrasonic vibrations have been applied to pass therethrough. As a result, the ultrasonic vibrations become weaker to reduce a cleaning effect on the object to be cleaned.

Accordingly, an ultrasonic shower cleaning device according to the present invention has been devised by the inventors of the present invention as a result of trial and error conducted to solve the problems described above. A vibrating body is provided inside a discharge port such that a part of the vibrating body projects to an outside of the discharge port in order to suppress the propagation of ultrasonic vibrations to a nozzle inner wall in the vicinity of the discharge port and thus reduce the damping of the ultrasonic vibrations. As a result, a sound pressure of a cleaning liquid to be ejected can be increased, and air bubbles can be made less likely to be accumulated on a surface of the vibrating body.

Thus, the present invention has an object to provide an ultrasonic shower cleaning device including a vibrating body that is provided inside a discharge port such that a part of the vibrating body as to be continuous from an inside of a flow passage and projects to an outside of the discharge port. The ultrasonic shower cleaning device efficiently applies an ultrasonic vibration to a cleaning liquid flowing through the flow passage so as to allow the cleaning liquid to be ejected in a spot-like or linear fashion to an object to be cleaned without scattering the cleaning liquid.

### Solution to Problem

In order to achieve the above-mentioned object, according to one aspect of the present invention, there is provided an ultrasonic shower cleaning device configured to clean an object to be cleaned through a cleaning liquid to which an ultrasonic vibration has been applied, the ultrasonic shower cleaning device including: a liquid supply port configured to allow supply of the cleaning liquid; a flow passage, which is continuous from the liquid supply port, and is configured to allow flow of the cleaning liquid flow; a vibrating body, which defines a part of the flow passage, and is configured to apply an ultrasonic vibration to the cleaning liquid; and a discharge port configured to allow discharge of the cleaning liquid flowing from the flow passage, in which the vibrating body is provided so as to be continuous from an inside of the flow passage and project to an outside of the discharge port.

Further, in the present invention, the cleaning liquid is allowed to flow out in a direction in which the vibrating body projects.

Further, in the present invention, the discharge port is formed in a spot-like shape, and the ultrasonic shower cleaning device is of a spot shower type.

Further, in the present invention, the vibrating body is arranged so as to be spaced apart by a predetermined distance from an inner peripheral surface defining the discharge port and project to the outside through the discharge port, and the flow passage is defined by the inner peripheral surface and the vibrating body.

Further, in the present invention, the discharge port is formed in a rectangular shape, and the ultrasonic shower cleaning device is of a line shower type.

Further, in the present invention, the vibrating body is arranged so as to be spaced apart by a predetermined distance from inner surfaces comprising a longitudinal direction defining the discharge port and project to the outside through the discharge port, and the flow passage is defined by the inner surfaces and the vibrating body.

### Advantageous Effects of Invention

According to the ultrasonic shower cleaning device of the present invention, the vibrating body is provided so as to be continuous from the inside of the flow passage and project to the outside of the discharge port. As a result, the propagation of ultrasonic vibrations to a nozzle inner wall in the vicinity of the discharge port can be suppressed. Accordingly, the damping of the ultrasonic vibration can be reduced to increase the sound pressure of the cleaning liquid to be ejected, and air bubbles can be made less likely to be accumulated on a surface of the vibrating body. In this manner, ultrasonic vibrations can be efficiently applied to the cleaning liquid flowing through the flow passage so that the cleaning liquid can be ejected in a spot-like or linear fashion to the object to be cleaned without being scattered.

Specifically, the ultrasonic shower cleaning device according to the present invention includes the vibrating body that is provided so as to be continuous from the inside of the flow passage and project to the outside of the discharge port. In this manner, the inner peripheral surface, which corresponds to the nozzle inner wall of a nozzle portion on a distal end side of the vibrating body, is reduced, thereby decreasing a length of the flow passage that extends to the discharge port and is a gap defined by the inner peripheral surface and an outer peripheral surface of the vibrating body. As a result, the flow passage to the discharge port defined by the inner peripheral surface of the nozzle inner wall is reduced. Further, the vibrating body projects to the outside of the discharge port, and the cleaning liquid flows from the discharge port along an outer periphery of the vibrating body while being in contact therewith. As a result, the propagation of the ultrasonic vibrations, which are superimposed on the cleaning liquid by the vibrating body, to the inner peripheral surface defining the discharge port is reduced, thereby being capable of reducing the damping of the ultrasonic vibrations applied to the cleaning liquid. As a result, the sound pressure of the cleaning liquid to be discharged can be increased, and thus a cleaning effect can be enhanced.

Further, in a related-art ultrasonic shower cleaning device, the cleaning liquid flows through the flow passage being a gap defined by the outer peripheral surface of the vibrating body and the inner wall surface of a nozzle main body and is discharged from the discharge port. Thus, a flow rate of the cleaning liquid through the flow passage that is narrow may be increased, which may result in the accumulation of air bubbles on the surface of the vibrating body. On the other hand, in the ultrasonic shower cleaning device according to the present invention, the inner peripheral surface of the nozzle inner wall on the distal end side of the vibrating body is reduced. As a result, air bubbles generated on the nozzle inner wall and at the distal end portion of the vibrating body can be reduced. Thus, the ultrasonic vibrations that have propagated from the vibrating body to the cleaning liquid are concentrated to increase the sound pressure. Further, air bubbles, which may inhibit the propagation of vibrations, are less likely to be accumulated. Thus, boil dry does not occur to thereby enable the prevention of a failure of the ultrasonic transducer.

Further, in the spot shower type ultrasonic shower cleaning device according to the present invention, the vibrating body is arranged so as to be spaced apart by the predetermined distance from the inner peripheral surface defining the discharge port and project to the outside through the discharge port. As a result, the ultrasonic vibrations propagating from the vibrating body are concentrated to the cleaning liquid, and the cleaning liquid is thus discharged. Thus, the cleaning liquid has a smaller diameter, and further, the sound pressure is increased. Accordingly, the cleaning effect can be enhanced, and thus a more pinpoint cleaning effect is obtained.

Further, in the line shower type ultrasonic shower cleaning device according to the present invention, the vibrating body is arranged so as to be spaced apart by the predetermined distance from the inner surfaces comprising the longitudinal direction defining the discharge port and project to the outside through the discharge port. Thus, the ultrasonic vibrations propagating from the vibrating body are concentrated to the cleaning liquid, and the cleaning liquid is thus discharged. Thus, a width of a line of the cleaning liquid is reduced, and further, the air pressure is increased. Accordingly, the cleaning effect can be enhanced.

Further, in the line shower type ultrasonic shower cleaning device according to the present invention, the vibrating body is arranged so as to be spaced apart by the predetermined distance from the inner surfaces comprising the longitudinal direction defining the discharge port and project to the outside through the discharge port. Thus, the generation of air bubbles is reduced, and the cleaning liquid can be uniformly ejected to a surface to be cleaned. Accordingly, the line shower type ultrasonic shower cleaning device is suitable for cleaning of, for example, glass substrates of various sizes.

### BRIEF DESCRIPTION OF DRAWINGS

FIG. 1 is a sectional view for illustrating a configuration of a spot shower type ultrasonic shower cleaning device according to the present invention.

FIG. 2 is a view for illustrating a flow passage for a cleaning liquid and ejection of the cleaning liquid from a distal end portion in FIG. 1.

FIG. 3 is a diagram for illustrating a configuration of a cleaning system that controls the spot shower type ultrasonic shower cleaning device.

FIG. 4 are views for schematically illustrating a size of a diameter of the cleaning liquid that is discharged under a state in which a vibrating body is accommodated inside a discharge port and a state in which a vibrating body projects to an outside of a discharge port, in which FIG. 4A is a view for illustrating the size of the diameter of the cleaning liquid under a state in which the vibrating body is accommodated inside the discharge port and FIG. 4B is a view for illustrating the size of the diameter of the cleaning liquid under a state in which the vibrating body projects to the outside of the discharge port.

FIG. 5 is a graph for showing results of measurements of a magnitude of a sound pressure of the cleaning liquid discharged from the spot shower type ultrasonic shower cleaning device.

FIG. 6 is a sectional view for illustrating a configuration of a line shower type ultrasonic shower cleaning device according to the present invention.

FIG. 7 is a sectional view for illustrating a configuration of a related-art stream ultrasonic cleaning device including a vibrating body that is built therein.

### DESCRIPTION OF EMBODIMENTS

An embodiment for implementing an ultrasonic shower cleaning device according to the present invention is now described with reference to the drawings. The present invention provides an ultrasonic shower cleaning device that efficiently applies an ultrasonic vibration to a cleaning liquid flowing through a flow passage to perform cleaning. In particular, the ultrasonic shower cleaning device can eject the cleaning liquid having strong energy of ultrasonic vibrations in a spot-like or linear fashion to an object to be cleaned without scattering the cleaning liquid.

[Configuration of Spot Shower Type Ultrasonic Shower Cleaning Device]

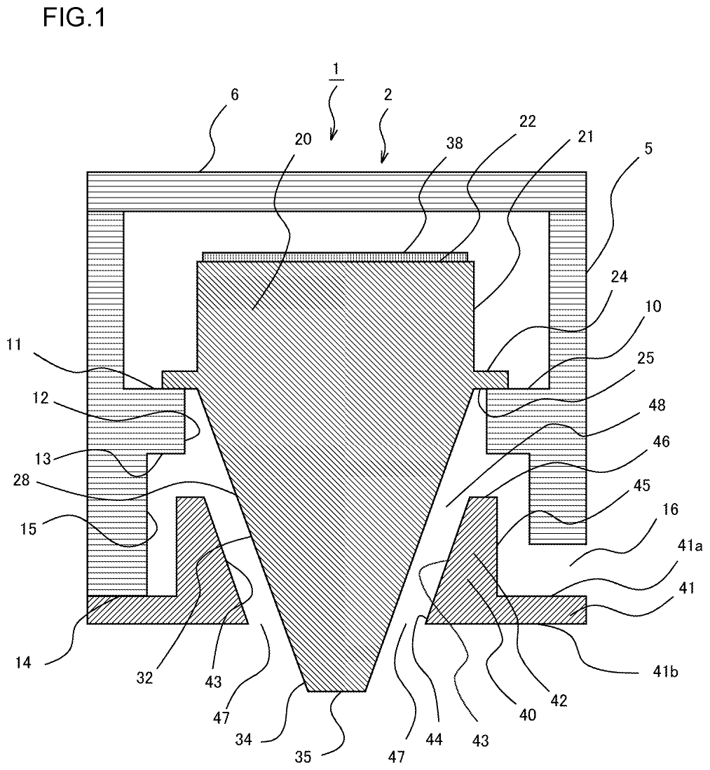

First, a configuration of a spot shower type ultrasonic shower cleaning device configured to apply an ultrasonic vibration to a liquid such as a cleaning liquid and discharge the liquid to an object to be cleaned is described with reference to FIG. 1. FIG. 1 is a sectional view for illustrating a configuration of a spot shower type ultrasonic shower cleaning device according to the present invention.

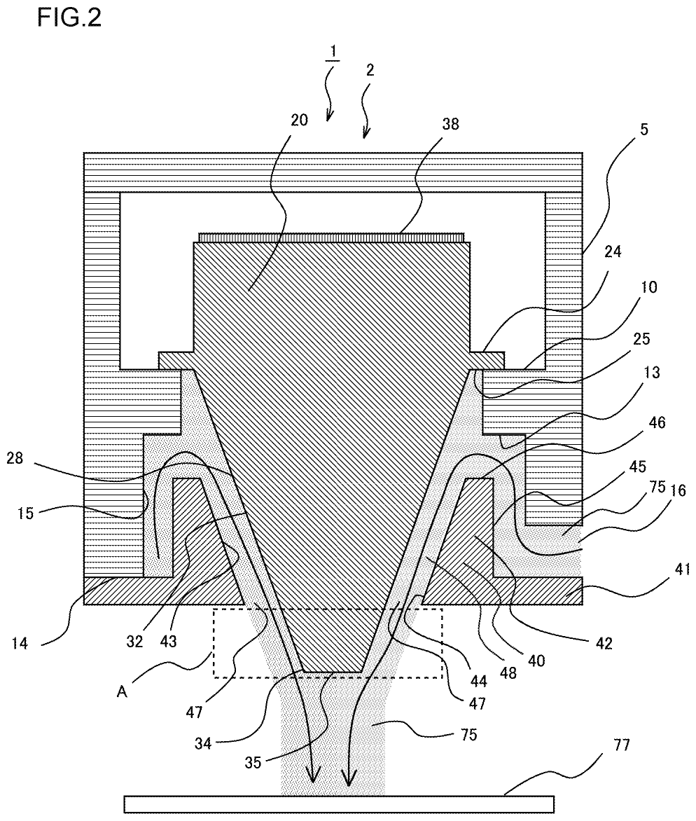

As illustrated in FIG. 1, a spot shower type ultrasonic shower cleaning device 2 corresponding to an ultrasonic shower cleaning device 1 includes a casing 5, a vibrating body 20, an ultrasonic transducer 38, a discharge port 47, a rectifying portion 40, and a liquid supply port 16. The vibrating body 20 is provided inside the casing 5 and is configured to apply an ultrasonic vibration to a cleaning liquid 75 (illustrated in FIG. 2). The ultrasonic transducer 38 applies a vibration to the vibrating body 20. The discharge port 47 is configured to allow discharge of the cleaning liquid 75. The rectifying portion 40 defines a part of a flow passage 48. The liquid supply port 16 is configured to allow supply of the cleaning liquid 75.

The casing 5 of the spot shower type ultrasonic shower cleaning device 2 is formed in a substantially cylindrical shape, and the vibrating body 20 is accommodated and fixed inside the casing 5. A vibrating-body retaining portion 10 that fixes the vibrating body 20 is formed on an inner wall surface of the casing 5 in the vicinity of a center in a vertical direction on the drawing sheet of FIG. 1. The vibrating-body retaining portion 10 forms a step in a ring-like shape projecting to an inside of the casing 5.

An upper lid 6 is provided on a top of the casing 5. Further, the liquid supply port 16 configured to allow the supply of the cleaning liquid 75 is formed in the vicinity of a bottom portion 14 that is located at a lower part of the casing 5. Further, the rectifying portion 40 is mounted to an end surface of the bottom portion 14 of the casing 5.

The vibrating body 20 applies ultrasonic vibrations to the cleaning liquid 75, and the cleaning liquid 75 to which the ultrasonic vibrations have been applied is ejected from a vibration surface 35 of a distal end portion 34 of the vibrating body 20. As illustrated in FIG. 1, the vibrating body 20 includes a vibration assisting portion 21, a flange portion 24, and a vibration transmitting portion 28. The vibration assisting portion 21 is an upper part of the vibrating body 20 and has a columnar shape. The flange portion 24 is formed in a projecting manner below the vibration assisting portion 21 and fixes the vibrating body 20 to the casing 5. The vibration transmitting portion 28 is formed below the flange portion 24 and has an inverted truncated conical shape. The vibrating body 20 is made of a metallic material. For example, SUS, stainless steel, or titanium is used.

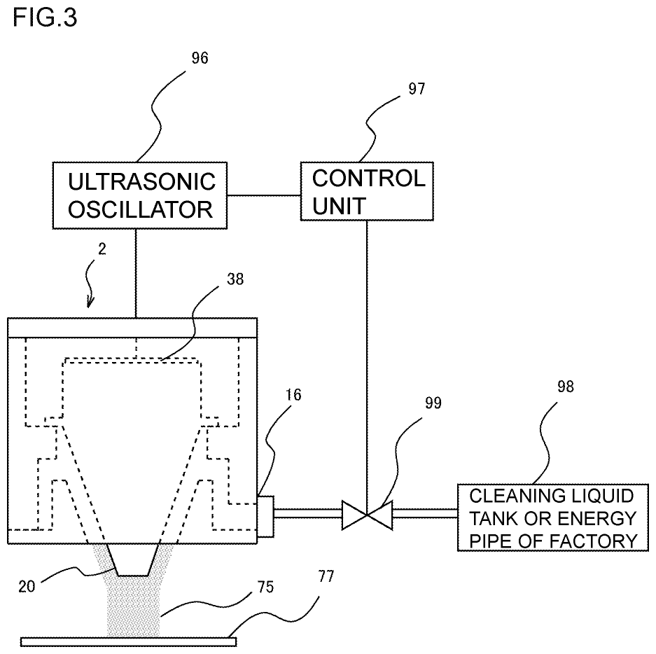

The ultrasonic transducer 38 is mounted onto an upper end 22 of the vibration assisting portion 21 so as to be in close contact therewith. Ultrasonic vibrations are applied to the vibrating body 20 by the ultrasonic transducer 38. When high-frequency power is supplied to the ultrasonic transducer 38 located at an upper end of the vibrating body 20 by an ultrasonic oscillator 96 (illustrated in FIG. 3), the ultrasonic transducer 38 is excited to thereby cause the vibrating body 20 to generate an ultrasonic vibration.

A bolted Langevin transducer (BLT) or a piezoelectric ceramic, which has a plate-like shape and is made of a ceramic material, is used as the ultrasonic transducer 38. The ultrasonic transducer 38 is fixed onto an upper surface of the vibrating body 20 by bolting or with an adhesive. A frequency of the ultrasonic transducer 38, which can be used for an ultrasonic shower cleaning device, is from 20 KHz to 3 MHz. A normally used frequency falls within a range of from 40 KHz to 200 KHz.

The vibration assisting portion 21 of the vibrating body 20 is designed so that ultrasonic vibrations from the ultrasonic transducer 38 firmly fixed to the upper end of the vibration assisting portion 21 propagate to the flange portion 24 and a magnitude of an amplitude of the vibrations becomes minimum at the flange portion 24. The vibration assisting portion 21 assists in transmission of ultrasonic vibrations.

The flange portion 24 of the vibrating body 20 is formed below the vibration assisting portion 21 so as to project outward. The flange portion 24 of the vibrating body 20 is formed in the vicinity of a node at which the magnitude of the amplitude of vibrations of the vibrating body 20 becomes minimum. The flange portion 24 of the vibrating body 20 is fixed to an upper surface 11 of the vibrating-body retaining portion 10 of the casing 5. Thus, a distal end surface 12 of the vibrating-body retaining portion 10 is only required to project to a position at which the upper surface 11 can be coupled to the flange portion 24 of the vibrating body 20, and the distal end surface 12 is not in contact with the vibration transmitting portion 28.

The flange portion 24 of the vibrating body 20 and the vibrating-body retaining portion 10 of the casing 5 are fixed by fixing their contact surfaces with an adhesive or with a bolt inserted in a through hole formed in the flange portion 24 and a threaded hole formed in the vibrating-body retaining portion 10. Even when the flange portion 24 is fixed to the vibrating-body retaining portion 10, the ultrasonic vibrations of the vibrating body 20 are little restricted. Thus, the ultrasonic vibrations of the vibrating body 20 are stable.

Further, inflow of the cleaning liquid 75 to the vibration assisting portion 21 side is prevented by fixing the flange portion 24 of the vibrating body 20 and the vibrating-body retaining portion 10 of the casing 5 to each other. Thus, the vibration assisting portion 21 of the vibrating body 20 and the ultrasonic transducer 38 are not brought into contact with the cleaning liquid 75, thereby being capable of preventing a failure.

The vibration transmitting portion 28, which has an inverted truncated conical shape and is formed below the flange portion 24, is a portion of the vibrating body 20, which is brought into contact with the cleaning liquid 75. The vibration transmitting portion 28 has an outer peripheral surface 32 and the distal end portion 34. The outer peripheral surface 32 has an inverted truncated conical shape. The outer peripheral surface 32 is gradually tapered toward the distal end portion 34 and defines the flow passage 48 which allows flow of the cleaning liquid 75 toward the discharge port 47 and the distal end portion 34. The distal end portion 34 located at a distal end of the vibrating body 20 has a circular shape in bottom view. The distal end portion 34 has the vibration surface 35 that vibrates longitudinally, and ultrasonic vibrations are applied by the vibration surface 35 to the cleaning liquid 75 flowing along the outer peripheral surface 32.

The vibration transmitting portion 28 extends continuously from an inside of the flow passage 48, the distal end portion 34 thereof projects from the discharge port 47, and the vibration surface 35 is arranged outside the discharge port 47, which corresponds to an anti-node at which an amplitude of vibrations propagating from the ultrasonic transducer 38 becomes larger. Further, the vibration transmitting portion 28 of the vibrating body 20 has a shape gradually tapered toward the distal end portion 34. Thus, the vibrations from the ultrasonic transducer 38 are amplified and propagate to the vibration surface 35 of the distal end portion 34. As a result, strong ultrasonic vibrations can be applied to the cleaning liquid 75.

The rectifying portion 40 is provided onto the bottom portion 14 located at the lower part of the casing 5. The rectifying portion 40 is mounted to the lower part of the casing 5, temporarily stores the cleaning liquid 75 supplied from the liquid supply port 16, and allows the cleaning liquid 75 to be supplied to an upper part of the outer peripheral surface 32 of the vibrating body 20.

The rectifying portion 40 includes a bottom portion 41 having an annular plate-like shape. A projecting portion 42 is formed on one surface 41a that is oriented upward in the spot shower type ultrasonic shower cleaning device 2 (oriented toward the upper lid 6). The projecting portion 42 has an inclined surface 43 that extends from an end of a circular hole of another surface 41b having an annular plate-like shape toward the one surface 41a. The projecting portion 42 is formed so that a space defined by the inclined surface 43 has an inverted truncated conical shape. The projecting portion 42 is formed to have a substantially trapezoidal sectional shape so that a gap is defined by the inclined surface 43 of the projecting portion 42 and a part of the outer peripheral surface 32 of the vibrating body 20.

The cleaning liquid 75 supplied from the liquid supply port 16 flows on the one surface 41a of the bottom portion 41 of the rectifying portion 40, an outer peripheral surface 45 perpendicular to the one surface 41a of the bottom portion 41, an upper surface 46 and the inclined surface 43 of the projecting portion 42. With this configuration, the flow passage 48 is defined by the outer peripheral surface 45 and the upper surface 46 of the projecting portion 42, an inner peripheral surface 15 of a lower part of the casing 5, and a lower surface 13 of the vibrating-body retaining portion 10, and further by the inclined surface 43 of the projecting portion 42 and the outer peripheral surface 32 of the vibration transmitting portion 28 of the vibrating body 20.

Further, as illustrated in FIG. 1, the discharge port 47 which allows discharge of the cleaning liquid 75 is located at a lower end of the inclined surface 43 at which the inclined surface 43 of the projecting portion 42 and the another surface 41b of the bottom portion 41 of the rectifying portion 40 intersect with each other. Specifically, the discharge port 47 is defined by a lower part of an inner peripheral surface 44 of the inclined surface 43.

As described above, the rectifying portion 40 supplies the cleaning liquid 75 to the vibrating body 20 by causing the cleaning liquid 75 supplied from the liquid supply port 16 to flow over the upper surface 46 of the projecting portion 42 of the rectifying portion 40. The rectifying portion 40 defines a part of the flow passage 48. The cleaning liquid 75 flows through the flow passage 48 continuously from the liquid supply port 16 from which the cleaning liquid 75 is supplied.

Further, the rectifying portion 40 mounted onto the bottom portion 14 of the casing 5 also serves as a temporary storage groove. Specifically, the rectifying portion 40 temporarily stores the cleaning liquid 75 supplied from the liquid supply port 16, causes the cleaning liquid 75 to flow over the upper surface 46 of the projecting portion 42 of the rectifying portion 40, and rectifies the cleaning liquid 75 into a uniform flow that is to be guided along the vibrating body 20.

Further, as illustrated in FIG. 1, the vibrating body 20 is arranged so as to be spaced apart by a predetermined distance from the inner peripheral surface 44 defining the discharge port 47 and partially project to the outside through the discharge port 47.

As described above, the vibrating body 20 illustrated in FIG. 1 is provided so as to have the outer peripheral surface 32 defining the flow passage 48 extending from the liquid supply port 16 and partially project to the outside of the discharge port 47, thereby allowing the cleaning liquid 75 to flow out in a direction in which the vibrating body 20 projects.

### [Flow Passage for Cleaning Liquid in Spot Shower Type Ultrasonic Shower Cleaning Device]

Next, the flow passage for the cleaning liquid in the spot shower type ultrasonic shower cleaning device and ejection of the cleaning liquid from the distal end portion to the object to be cleaned are described with reference to FIG. 2. FIG. 2 is a view for illustrating the flow passage for the cleaning liquid and the ejection of the cleaning liquid from the distal end portion in FIG. 1.

As illustrated in FIG. 1 and FIG. 2, the cleaning liquid 75 supplied from the liquid supply port 16 flows along the bottom portion 41 of the rectifying portion 40, flows through a space defined by the inner peripheral surface 15 of the casing 5 and the outer peripheral surface 45 of the projecting portion 42 of the rectifying portion 40 and a space defined by the lower surface 13 of the vibrating-body retaining portion 10 and the upper surface 46 of the projecting portion 42, and is supplied to the upper part of the vibration transmitting portion 28 of the vibrating body 20. As described above, the space defined by the projecting portion 42 of the rectifying portion 40, the lower surface 13 of the vibrating-body retaining portion 10, and the inner peripheral surface 15 on the lower end side of the casing 5 forms a part of the flow passage 48 for the cleaning liquid 75.

Further, the cleaning liquid 75 supplied to the upper part of the vibration transmitting portion 28 of the vibrating body 20 flows through the space extending to the discharge port 47, which is defined by the outer peripheral surface 32 of the vibration transmitting portion 28 and the inner peripheral surface 44 of the rectifying portion 40, and flows along the outer peripheral surface 32 extending to the distal end portion 34 of the vibration transmitting portion 28 projecting from the discharge port 47.

As described above, the space extending to the discharge port 47, which is defined by the outer peripheral surface 32 of the vibration transmitting portion 28 of the vibrating body 20 and the inner peripheral surface 44 of the rectifying portion 40, and the outer peripheral surface 32, which extends from the discharge port 47 to the distal end portion 34 of the vibration transmitting portion 28, form a part of the flow passage 48.

Ultrasonic vibrations are applied to the cleaning liquid 75 that flows through the flow passage 48 to the distal end portion 34 by the vibration surface 35 of the vibration transmitting portion 28 of the vibrating body 20 and is ejected in a direction perpendicular to the vibration surface 35. The cleaning liquid 75 that leaves the vibration surface 35 is ejected as a beam-like stream to the object to be cleaned 77.

The vibrating body 20 is mounted into the casing 5 so that, when the spot shower type ultrasonic shower cleaning device 2 is installed with a center axis of the casing 5, which extends in the vertical direction on the drawing sheets of FIG. 1 and FIG. 2, aligned vertically, a lower part 25 of the flange portion 24 of the vibrating body 20 is located at a highest position in the flow passage 48 for the cleaning liquid 75, which extends along the vibrating body 20.

As illustrated in FIG. 1 and FIG. 2, the vibrating body 20 is provided so as to project to the outside of the discharge port 47 defined by the inner peripheral surface 44 of the rectifying portion 40. The cleaning liquid 75 flows continuously through the flow passage 48 defined by the lower surface of the flange portion 24 in a direction in which the vibrating body 20 projects to the outside through the discharge port 47. Then, ultrasonic vibrations are applied to the cleaning liquid 75 by the vibration surface 35 of the distal end portion 34.

As a result, as illustrated in FIG. 2, the cleaning liquid 75 is in contact only with the outer peripheral surface 32 of the vibration transmitting portion 28 of the vibrating body 20 and is not in contact with the casing 5 or the rectifying portion 40 when flowing through a region A surrounded by the broken line, which includes a projecting part of the vibration transmitting portion 28 to the outside through the discharge port 47. Thus, ultrasonic vibrations do not propagate to the casing 5 or the rectifying portion 40 through the cleaning liquid 75. Accordingly, no loss of ultrasonic vibrations occurs, and thus the damping of the ultrasonic vibrations applied to the cleaning liquid 75 can be reduced.

Further, the outer peripheral surface 32 in the vicinity of the vibration surface 35 of the distal end portion 34 of the vibration transmitting portion 28 is not in proximity to the casing 5 or the rectifying portion 40. Thus, there is only a space around the outer peripheral surface 32 in the vicinity of the vibration surface 35, and the generation or the stagnation of air bubbles does not occur. Thus, for example, boil dry can be prevented. Further, because of no generation or stagnation of air bubbles, ultrasonic vibrations can be efficiently applied to the cleaning liquid 75 by the vibration surface 35. As a result, the cleaning liquid 75 to which strong ultrasonic vibrations have been applied is released from the vibrating body 20.

### [Configuration of Cleaning System]

Next, a configuration of a cleaning system that controls an ultrasonic shower cleaning device is described. FIG. 3 is a view for illustrating a configuration of a cleaning system that controls the spot shower type ultrasonic shower cleaning device.

As illustrated in FIG. 3, when high-frequency power is applied to the ultrasonic transducer 38 of the spot shower type ultrasonic shower cleaning device 2 by the ultrasonic oscillator 96, the ultrasonic transducer 38 generates ultrasonic vibrations. The cleaning liquid 75 is supplied to the liquid supply port 16 of the spot shower type ultrasonic shower cleaning device 2 from, for example, a cleaning liquid tank 98 or an energy pipe 98 of a factory via a cleaning-liquid supply valve 99.

Further, the spot shower type ultrasonic shower cleaning device 2 is controlled by a control unit 97. The control unit 97 is formed of a program-executable computer and performs various types of processing. The control unit 97 performs ON/OFF control 1 of oscillation of the ultrasonic oscillator 96 and control for allowing and interrupting passage of water through the cleaning-liquid supply valve 99.

In the above-mentioned manner, the cleaning device can also be automated. The configuration of the cleaning system that controls the ultrasonic shower cleaning device, which is illustrated in FIG. 3, is an example, and is not limited thereto.

[Magnitude of Sound Pressure and Size of Diameter of Cleaning Liquid Discharged from Spot Shower Type Ultrasonic Shower Cleaning Device]

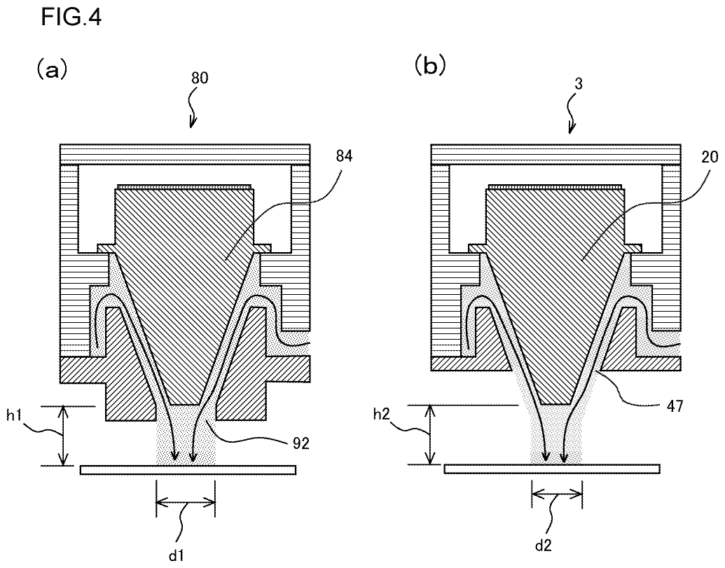

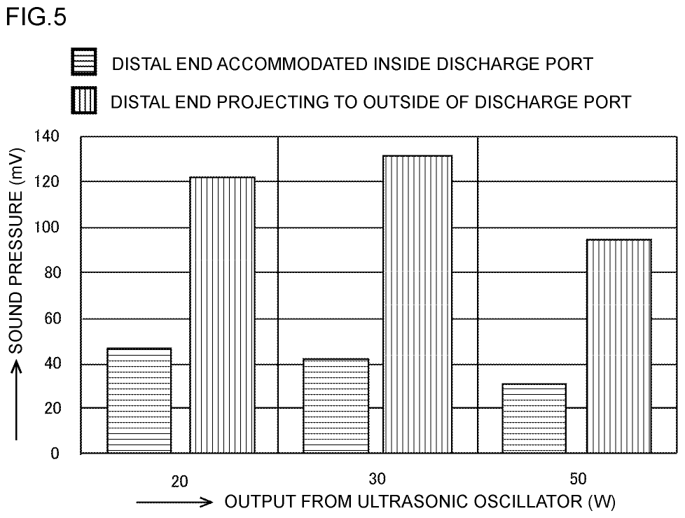

With reference to FIG. 4 and FIG. 5, a magnitude of a sound pressure and a size of a diameter of the cleaning liquid discharged from the spot shower type ultrasonic shower cleaning device according to the present invention are described. FIG. 4 are views for schematically illustrating a size of a diameter of the cleaning liquid that is discharged under a state in which a vibrating body is accommodated inside a discharge port and a state in which the vibrating body projects to the outside of the discharge port, in which FIG. 4A is a view for illustrating the size of the diameter of the cleaning liquid under a state in which the vibrating body is accommodated inside the discharge port and FIG. 4B is a view for illustrating the size of the diameter of the cleaning liquid under a state in which the vibrating body projects to the outside of the discharge port. Further, FIG. 5 is a graph for showing results of measurements of a magnitude of a sound pressure of the cleaning liquid discharged from the spot shower type ultrasonic shower cleaning device.

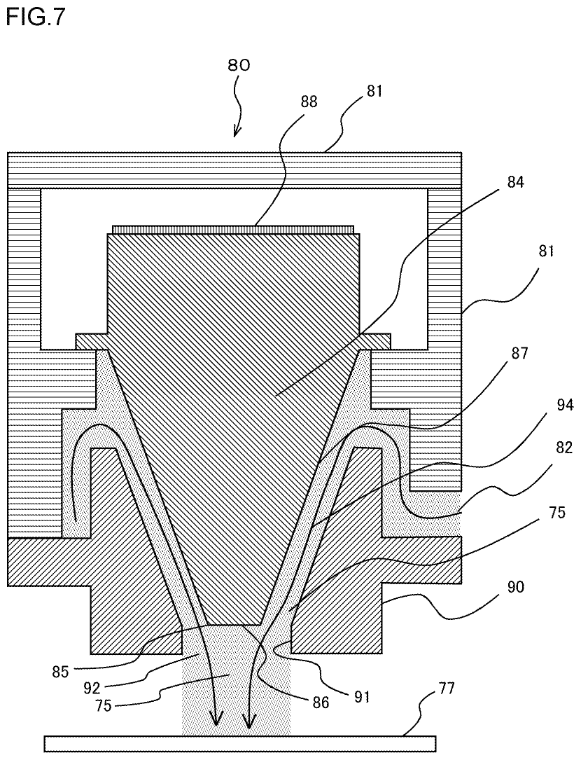

In this case, in FIGS. 4, the size of the diameter of the discharged cleaning liquid 75 is schematically illustrated for both of the state in which a vibrating body 84 is accommodated inside a discharge port 92 and the state in which the vibrating body 20 projects to the outside of discharge port 47. FIG. 4A is a view for illustrating a state in which the vibrating body 84 illustrated in FIG. 7 is accommodated inside the discharge port 92, and FIG. 4B is a view for illustrating a state in which the vibrating body 20 illustrated in FIG. 1 and FIG. 2 projects to the outside of the discharge port 47. Further, FIG. 5 is a graph for showing the results of measurements of a magnitude of a sound pressure of the discharged cleaning liquid with respect to an output from the ultrasonic oscillator for both of the state in which the vibrating body is accommodated inside the discharge port and the state in which the vibrating body projects to the outside of the discharge port in the spot shower type ultrasonic shower cleaning device.

A drive frequency of the ultrasonic transducer in the spot shower type ultrasonic shower cleaning device was about 45 KHz. The sound pressure was measured with use of a measurement probe of a sound pressure meter, which was installed immediately below the vibration surface of the distal end portion of the vibrating body so as to be spaced apart therefrom by 8 mm.

Specifically, under a state in which the vibrating body 84 illustrated in FIG. 7 was accommodated inside the discharge port 92 as illustrated in FIG. 4A, a sound pressure was measured with use of a measurement probe of a sound pressure meter, which was installed at a position immediately below a vibration surface 86 (FIG. 7) of a distal end portion 85 of the vibrating body 84 so as to be spaced apart therefrom by 8 mm. A distance h1 illustrated in FIG. 4A corresponds to the distance of 8 mm. Further, as illustrated in FIG. 4B, a sound pressure was measured with use of a measurement probe of a sound pressure meter, which was installed at a position immediately below the vibration surface 35 (FIG. 1 and FIG. 2) of the distal end portion 34 of the vibrating body 20 illustrated in FIG. 1 and FIG. 2 so as to be spaced apart therefrom by 8 mm. A distance h2 illustrated in FIG. 4B corresponds to the distance of 8 mm.

The distance of 8 mm corresponds to a length being an integral multiple of a quarter wavelength of the drive frequency of the ultrasonic transducer. Further, the sound pressure of the cleaning liquid 75 discharged from the spot shower type ultrasonic shower cleaning device was measured when the output from the ultrasonic oscillator was 20 watts (W), 30 W, and 50 W. In the measurement, the object to be cleaned 77 illustrated in FIG. 4 was not placed.

As shown in FIG. 5, when the output from the ultrasonic oscillator was 20 W, the magnitude of the sound pressure of the cleaning liquid 75 discharged from the spot shower type ultrasonic shower cleaning device was 47 mV under a state in which the distal end portion 85 of the vibrating body 84 was accommodated inside the discharge port 92 and was 122 mV under a state in which the distal end portion 34 of the vibrating body 20 projected to the outside of the discharge port 47. Further, when the output from the ultrasonic oscillator was 30 W, the magnitude of the sound pressure was 42 mV under a state in which the distal end portion 85 of the vibrating body 84 was accommodated inside the discharge port 92 and was 132 mV under a state in which the distal end portion 34 of the vibrating body 20 projected to the outside of the discharge port 47. Further, when the output from the ultrasonic oscillator was 50 W, the magnitude of the sound pressure was 31 mV under a state in which the distal end portion 85 of the vibrating body 84 was accommodated inside the discharge port 92 and was 95 mV under a state in which the distal end portion 34 of the vibrating body 20 projected to the outside of the discharge port 47.

As described above, it was confirmed that the sound pressure of the cleaning liquid 75 discharged from the distal end portion of the vibrating body, which was generated by the ultrasonic vibrations, in the spot shower type ultrasonic shower cleaning device illustrated in FIG. 1 and FIG. 2, in which the vibrating body 20 projects to the outside of the discharge port 47, was about three times as large as that of the cleaning liquid in the related-art spot shower type ultrasonic shower cleaning device (illustrated in FIG. 7), in which the vibrating body 84 is accommodated inside the discharge port 92.

Further, as illustrated in FIGS. 4, a size of a diameter d1 of the cleaning liquid 75 discharged under a state in which the vibrating body 84 was accommodated inside the discharge port 92 (FIG. 4A) was about 22 mm, and a size of a diameter d2 of the cleaning liquid 75 discharged under a state in which the vibrating body 20 projected to the outside of the discharge port 47 was about 14 mm.

Specifically, the size of the diameter of the cleaning liquid 75 discharged under a state in which the vibrating body 20 projected to the outside of the discharge port 47 was about 64% of the size of the diameter of the cleaning liquid 75 discharged under a state in which the vibrating body 84 was accommodated inside the discharge port 92.

As described above, together with a rise in sound pressure of the cleaning liquid 75 discharged from the spot shower type ultrasonic shower cleaning device 2, a beam-like narrowed flow of the cleaning liquid 75, which has a smaller diameter, can be obtained from the spot shower type ultrasonic shower cleaning device 2 in which the vibrating body 20 projects to the outside of the discharge port 47. Thus, the beam-like narrowed flow of the cleaning liquid 75 can be ejected to a surface of the object to be cleaned 77. Accordingly, the spot shower type ultrasonic shower cleaning device 2 is optimal for cleaning of, for example, a surface of a semiconductor wafer and components.

### [Configuration of Line Shower Type Ultrasonic Shower Cleaning Device]

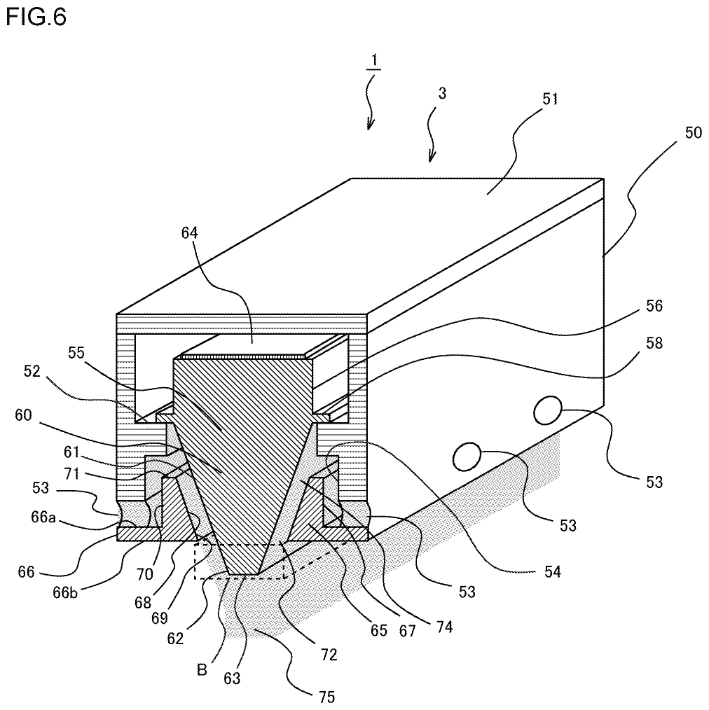

Next, a line shower type ultrasonic shower cleaning device is described with reference to FIG. 6. FIG. 6 is a sectional view for illustrating a configuration of a line shower type ultrasonic shower cleaning device according to the present invention. The principle itself of the line shower type ultrasonic shower cleaning device is similar to that of the spot shower type ultrasonic shower cleaning device according to the present invention, which has already been described above. Thus, detailed description of the configuration is omitted.

As illustrated in FIG. 6, a line shower type ultrasonic shower cleaning device 3 corresponding to the ultrasonic shower cleaning device 1 includes a casing 50, a vibrating body 55, an ultrasonic transducer 64, discharge ports 72, rectifying portions 65, and liquid supply ports 53. The vibrating body 55 is provided inside the casing 50 and is configured to apply an ultrasonic vibration to the cleaning liquid 75. The ultrasonic transducer 64 applies a vibration to the vibrating body 55. The discharge ports 72 are configured to allow discharge of the cleaning liquid 75. The rectifying portions 65 define a part of flow passages 74. The liquid supply ports 53 are configured to allow supply of the cleaning liquid 75. In this case, as illustrated in FIG. 6, the components of the line shower type ultrasonic shower cleaning device 3 except for the liquid supply ports 53 are formed linearly so as to extend continuously to a rear side on the drawing sheet of FIG. 6. The following description is given on the premise that the above-mentioned components except for the liquid supply ports 53 extend continuously to the rear side on the drawing sheet of FIG. 6.

The casing 50 of the line shower type ultrasonic shower cleaning device 3 is formed in a cuboidal shape. The vibrating body 55 is accommodated and fixed inside the casing 50. Vibrating-body retaining portions 52 that fix the vibrating body 50 are formed on wall surfaces of both inner side surfaces of the casing 50 that extend in a longitudinal direction of the casing 50 and are illustrated in the vicinity of a center in a vertical direction on the drawing sheet of FIG. 6. The vibrating-body retaining portions 52 are each formed in a square bar-like shape projecting inwardly from the wall surface.

An upper lid 51 is provided on a top of the casing 50. Further, a plurality of liquid supply ports 53 configured to allow the supply of the cleaning liquid 75 are formed in the vicinity of lower distal ends of both side surfaces extending in the longitudinal direction of the casing 50. Further, the rectifying portions 65 are mounted to both end surfaces of a bottom portion located at a lower part of the casing 50.

The vibrating body 55 applies ultrasonic vibrations to the cleaning liquid 75, and the cleaning liquid 75 to which the ultrasonic vibrations have been applied is discharged from the line shower type ultrasonic shower cleaning device 3. As illustrated in FIG. 6, the vibrating body 55 includes a vibration assisting portion 56, flange portions 58, and a vibration transmitting portion 60. The vibration assisting portion 56 has a cuboidal shape, and has an oblong rectangular shape in cross section in FIG. 6. The flange portions 58 are formed below the vibration assisting portion 56 so as to project toward both side surfaces of the casing 50 in the longitudinal direction thereof in cross section in FIG. 6, and fix the vibrating body 55 to the casing 50. The vibration transmitting portion 60 is formed below the flange portions 58, and has an inverted isosceles trapezoidal shape in cross section in FIG. 6. The vibrating body 55 is made of a metallic material. For example, SUS, stainless steel, or titanium is used.

The ultrasonic transducer 64 is mounted onto an upper end of the vibration assisting portion 56 so as to be in close contact therewith. Ultrasonic vibrations are applied to the vibrating body 55 by the ultrasonic transducer 64. High-frequency power is supplied to the ultrasonic transducer 64 located at the upper end of the vibrating body 55 by an ultrasonic oscillator to thereby excite ultrasonic vibrations in the vibrating body 55.

A piezoelectric ceramic that has a plate-like shape and is made of a ceramic material is used as the ultrasonic transducer 64. The ultrasonic transducer 64 is not limited to a piezoelectric ceramic having a plate-like shape and may be, for example, a bolted Langevin transducer (BLT).

The rectifying portions 65 are provided onto a lower end of the casing 50. The rectifying portions 65 are mounted to lower parts of opposed side surfaces of the casing 50 in the longitudinal direction thereof, respectively. The rectifying portions 65 temporarily store the cleaning liquid 75 supplied from the liquid supply ports 53, and allow the cleaning liquid 75 to be supplied to upper parts of outer side surfaces 61 of the vibration transmitting portion 60.

Each of the rectifying portions 65 includes a bottom portion 66 having an oblong plate-like shape in cross section in FIG. 6. The rectifying portion 65 includes a projecting portion 67 formed on one surface 66a of the bottom portion 66. The projecting portion 67 has an inclined surface 68. The inclined surface 68 extends from an inner end of another surface 66b of the bottom portion 66 extending in the longitudinal direction of the casing 50, and extends toward and beyond the one surface 66a. A cross section of the projecting portion 67 is inclined so that a gap is defined between the inclined surface 68 of the projecting portion 67 and a part of the outer side surface 61 of the vibration transmitting portion 55.

Each of the rectifying portions 65 has one surface 66a of the bottom portion 66, an outer side surface 70 perpendicular to the one surface 66a, and an upper surface 71 and the inclined surface 68 of the projecting portion 67, which define a part of the flow passage 74 for the cleaning liquid 75. The flow passage 74 is defined by the outer side surface 70 and the upper surface 71 of the projecting portion 67, an inner side surface 54 of the casing 50, and a lower surface of the vibrating-body retaining portion 52 and further by the inclined surface 68 of the projecting portion 67 and the outer side surface 61 of the vibration transmitting portion 60 of the vibrating body 55.

Further, as illustrated in FIG. 6, each of the discharge ports 72 which allows discharge of the cleaning liquid 75 is located at an end of the inclined surface 68 at which the inclined surface 68 of the projecting portion 67 and the another surface 66b of the bottom portion 66 of the rectifying portion 65 intersect with each other. Specifically, each of the discharge ports 72 is defined by an inner side surface 69 of a lower part of the inclined surface 68.

As described above, each of the discharge ports 72 is formed in a rectangular shape in bottom view so as to extend continuously to the rear side on the drawing sheet of FIG. 6. The vibrating body 55 is arranged so as to be spaced apart by a predetermined distance from both opposed inner surfaces comprising the longitudinal direction defining the discharge ports 72, and the vibrating body 55 is arranged so as to extend continuously to the rear side on the drawing sheet of FIG. 6 and project to an outside through the discharge ports 72. Thus, the vibrating body 55 defines the discharge ports 72 in the longitudinal direction. A gap between each of the opposed inner surfaces defining the discharge ports 72 in the longitudinal direction, and the vibrating body 55 serves as the flow passage 74.

As illustrated in FIG. 6, the vibrating body 55 is provided so as to project to the outside through the discharge ports 72 beyond the inner side surfaces 69 of the rectifying portions 65. The cleaning liquid 75 flows through the flow passages 74 below the lower surfaces of the flange portions 58 and flows continuously in a direction in which the vibrating body 55 projects to the outside through the discharge ports 72. Then, ultrasonic vibrations are applied to the cleaning liquid 75 by a vibration surface 63 of the distal end portion 62.

In this manner, the cleaning liquid 75 is brought into contact only with the outer side surfaces 61 of the vibration transmitting portion 60 of the vibrating body 55 and is not brought into contact with the casing 50 or the rectifying portions 65 when flowing through a region B surrounded by the broken line, which includes a projecting part of the vibration transmitting portion 60 to an outside through the discharge ports 72. Thus, the ultrasonic vibrations do not propagate to the casing 50 or the rectifying portions 65 through the cleaning liquid 75. Accordingly, no loss of ultrasonic vibrations occurs, and thus the damping of the ultrasonic vibrations applied to the cleaning liquid 75 can be reduced.

Further, the outer side surfaces 61 in the vicinity of the vibration surface 63 at the distal end portion 62 of the vibration transmitting portion 60 are not in proximity to the casing 50 or the rectifying portions 65. Thus, there is only a space around the outer side surfaces 61 in the vicinity of the vibration surface 63, and the generation or stagnation of air bubbles does not occur. Thus, for example, boil dry can be prevented. Further, because of no generation or stagnation of air bubbles, ultrasonic vibrations can be efficiently applied to the cleaning liquid 75 by the vibration surface 63. As a result, the cleaning liquid 75 to which strong ultrasonic vibrations have been applied is released from the line shower type ultrasonic shower cleaning device 3.

In the above, the at least one embodiment of the present invention is described, but this embodiment is presented as an example, and is not intended to limit the scope of the invention. This embodiment may be implemented in other various modes, and various kinds of omissions, replacements, and modifications can be made thereto without departing from the gist of the invention. Those replacements and modifications thereof are included in the scope and gist of the invention, and are included in the scopes of the invention described in the appended claims and their equivalents. Further, the functional blocks illustrated in the functional block diagram of FIG. 3 show functional components of the at least one embodiment of the present invention, and do not limit specific embodiment modes.

### REFERENCE SIGNS LIST

1 ultrasonic shower cleaning device
2 spot shower type ultrasonic shower cleaning device
3 line shower type ultrasonic shower cleaning device
5, 50, 81 casing
6, 51 upper lid
10, 52 vibrating-body retaining portion
11 upper surface
12 distal end surface
13 lower surface
14 bottom portion
15, 54 inner peripheral surface (of lower part of casing)
16, 53, 82 liquid supply port
20, 55, 84 vibrating body
21, 56 vibration assisting portion
22 upper end of vibration assisting portion
24, 58 flange portion
25 lower part (lower surface) of flange portion
28, 60 vibration transmitting portion
32, 61, 87 outer peripheral surface of vibration transmitting portion (contact surface with cleaning liquid)
34, 62, 85 distal end portion (vibration surface)
35, 63 vibration surface
38, 64, 88 ultrasonic transducer
40, 65 rectifying portion
41, 66 bottom portion
41a, 66a one surface of bottom portion
41b, 66b another surface of bottom portion
42, 67 projecting portion
43, 68 inclined surface
44, 69 inner peripheral surface
45, 70 outer peripheral surface
46, 71 upper surface
47, 72, 92 discharge port
48, 74, 94 flow passage
75 cleaning liquid
77 object to be cleaned
80 stream ultrasonic cleaning device
90 nozzle portion
91 nozzle inner wall
96 ultrasonic oscillator
97 control unit
98 cleaning liquid tank
99 cleaning-liquid supply valve

1. An ultrasonic shower cleaning device of a stream spot shower type configured to clean an object to be cleaned through a cleaning liquid to which an ultrasonic vibration has been applied, the ultrasonic shower cleaning device comprising:
a liquid supply port configured to allow supply of the cleaning liquid;
a flow passage, which is continuous from the liquid supply port, and is configured to allow flow of the cleaning liquid;
a vibrating body, which defines a part of the flow passage, and is configured to apply an ultrasonic vibration to the cleaning liquid; and
a discharge port configured to allow discharge of the cleaning liquid flowing from the flow passage,
wherein the vibrating body is provided so as to be continuous from an inside of the flow passage and project to an outside of the discharge port.

2. The ultrasonic shower cleaning device according to claim 1, wherein the cleaning liquid is allowed to flow out in a direction in which the vibrating body projects.

3. The ultrasonic shower cleaning device according to claim 1,
wherein the discharge port is formed in a spot-like shape,
wherein the vibrating body is arranged so as to be spaced apart by a predetermined distance from an inner peripheral surface defining the discharge port and project to the outside through the discharge port, and
wherein the flow passage is defined by the inner peripheral surface and the vibrating body.

4. The ultrasonic shower cleaning device according to claim 1, wherein the vibrating body includes a vibration transmitting portion having an inverted truncated conical outer peripheral surface and a distal end portion, the outer peripheral surface defines a flow passage configured to allow flow of the cleaning liquid toward the distal end portion, and the distal end portion has a vibration surface that is arranged at such a position as to project to the outside through the discharge port.

5. An ultrasonic shower cleaning device of a stream line shower type configured to clean an object to be cleaned through a cleaning liquid to which an ultrasonic vibration has been applied, the ultrasonic shower cleaning device comprising:
a liquid supply port configured to allow supply of the cleaning liquid;
a flow passage, which is continuous from the liquid supply port, and is configured to allow flow of the cleaning liquid;
a vibrating body, which defines a part of the flow passage, and is configured to apply an ultrasonic vibration to the cleaning liquid; and
a discharge port configured to allow discharge of the cleaning liquid flowing from the flow passage,
wherein the vibrating body is provided so as to be continuous from an inside of the flow passage and project to an outside of the discharge port.

6. The ultrasonic shower cleaning device according to claim 5, wherein the cleaning liquid is allowed to flow out in a direction in which the vibrating body projects.

7. The ultrasonic shower cleaning device according to claim 5,
wherein the discharge port is formed in a rectangular shape,
wherein the vibrating body is arranged so as to be spaced apart by a predetermined distance from inner surfaces comprising a longitudinal direction defining the discharge port and project to the outside through the discharge port, and
wherein the flow passage is defined by the inner surfaces and the vibrating body.

8. The ultrasonic shower cleaning device according to claim 5, wherein the vibrating body includes a vibration transmitting portion including an outer peripheral surface and a distal end portion and having an inverted isosceles trapezoidal shape, the outer peripheral surface defines a flow passage configured to allow flow of the cleaning liquid toward the distal end portion, and the distal end portion has a vibration surface that is arranged at such a position as to project to the outside through the discharge port.
